(19) United States
(12) Patent Application Publication
(10) Pub. No.: US 2005/0235805 A1
(43) Pub. Date: Oct. 27, 2005

(54) Travel banjo

(76) Inventor: Samuel David Farris, Franklin, TN (US)

Correspondence Address: Samuel D. Farris, 409 Benton Lane, Franklin, TN, 37067, US

(21) Appl. No.: 11/109,440

(22) Filed: Apr. 19, 2005

Related U.S. Application Data
(60) Provisional application No. 60/564,203, filed on Apr. 21, 2004.

(51) Int. Cl. G10D 1/10; G10D 3/00

(52) U.S. Cl. 84/269

(57) ABSTRACT

A travel banjo optimized for sound quality, portablity and ruggedness. The neck, fingerboard and string scale are identical to a regular banjo. The neck is attached to the body with a thumbscrew. The body consists of a front and back plate which are fastened together mechanically. A commercial drum head is tensioned by the force of the front and back plates being drawn together, applying pressure to the head and the tone ring. A string clamp is attached by a thumbscrew to retain the strings and bridge in when the neck is removed. The strings are attached to string posts at the end of the neck travelling over the bridge to a set of rollers, which redirect the string path to the rear where the tuning mechanisms are mounted in a protected area. The head and bridge are similar to a regular banjo to provide an authentic banjo sound.

### RELATED APPLICATIONS

The present application is a continuation-in-part application of U.S. provisional patent application, Ser. No. 60/564203, filed Apr. 21, 2004, for TRAVEL BANJO, by Samuel D Farris, included by reference herein and for which benefit of the priority date is hereby claimed.

### FIELD OF THE INVENTIONS

The present invention relates to musical instruments and, more particularly, to a travel banjo which affords the musician the sound and playability of a full-sized instrument, while offering a removeable neck to allow reconfiguration to a more convenient size for portability and protected tuning hardware for ruggedness.

### BACKGROUND OF THE INVENTION

Banjo players who wish to practice while away from home have always faced the inconvenience of transporting a valuable instrument and risking damage, or using an inferior instrument and thus compromising the effective of their practice time. A conventional banjo is too large to meet most airline carry-on baggage restrictions, forcing the player to entrust their instruments to baggage handlers and conveyor belts. The ideal solution would be a banjo which plays and sounds like a conventionally sized banjo, but with a smaller body and removable neck. That way the banjo can be packed in a small suitcase which conforms to airline carry-on restrictions, and still leave room for a traveler's clothes and accessories. Upon arrival at their destination, the banjo player can reattach the neck in a few moments and enjoy practicing on an instrument that feels identical to the one they left at home.

Conventional, full-sized banjos use a head with a diameter of about eleven inches. In this design, any size head can be used, by adjusting the relative size of the front body plate, rear body plate, and the tone ring. In the travel-sized embodiment, a head assembly diameter of about six inches is preferred, as this is usually the smallest pre-manufactured head easily obtained from drum suppliers. To reduce the overall weight of the instrument, portions of the front body plate and rear body plate could be hollowed out or removed from areas that do not affect construction. The overall shape of the body need not be round and can be formed to any shape desirable.

The acoustic tones produced by playing the instrument would vary based on the materials used in construction. The front and back plates could be made of wood, metal, plastic or other synthetic materials, machined or molded to the correct dimensions. The neck and the tone ring can also be made from metal, wood or synthetics. The prototype of this instrument used a front and rear body plate made of wood, and a tone ring cut from a length of PVC pipe. The thickness, diameter, and composition of the head will also affect the tone. String composition and type of paint or varnish (if used), are other factors that affect the tonal characteristics.

Other embodiments and enhancements of the design include, but are not limited to the following:

1. Varying the number of strings, including a six-string configuration like a guitar, or an eight-string configuration like a mandolin. The number of rollers and tuning mechanisms would vary accordingly.

2. The length and width of the neck can also be varied to correspond to a guitar, tenor banjo, mandolin, or other stringed instrument. Most neck designs include fixed frets and inlaid or painted position markers to aid in correct fingering. A fixed or adjustable neck-strengthening device, such as a truss rod, is usually installed.

3. Although loop-ended banjo strings are shown in FIG. 5, the post could easily be modified to accept standard ball-ended guitar strings.

4. To improve player comfort, a retractable armrest could be added to the front body plate to correspond to armrests found on full-sized banjos.

5. Adding a shortened drone string, such as found in a conventional 5-string bluegrass banjo. This shortened string could be attached partway up the neck by a conventional 5th string tuning mechanism, with the other end of the string fastened to a post on the front body plate. Alternately, an additional tuning mechanism could be affixed to the rear body plate, and an additional roller installed. The other end of the drone string could then be anchored to a post installed partway up the neck, or “tunneled” within the neck to a post at the end of the neck, similar to the traditional European zither-banjo construction method.

6. An electromagnetic, piezo or similar transducer or pickup could be installed on body or head assembly, to provide an amplified, electric guitar sound. Alternately, a conventional banjo-style pickup could be attached to the head to provide an amplified sound similar to an acoustic banjo. Both types of pickup could be installed on the same instrument to allow the performer to switch sounds easily.

7. If overall instrument length was not a concern, construction could be simplified even further by eliminating the rollers, and mounting the tuning mechanisms on a conventional-style peghead at the end of the neck. The opposite end of the strings would be attached to strings posts mounted on the front body plate, or a conventional banjo tailpiece could be installed. Five string banjo configurations would add a conventional 5th string tuner partway up the neck.

8. Although the tone ring is indicated as a separate part, it could be manufactured as an integral extension of the rear body plate. The neck could also be manufactured as an integral extension of either the front or rear body plate.

9. The raised portions of the rear body plate, upon which the tuning mechanisms are mounted, could be manufactured as separate parts, then affixed to the rear body plate by adhesives or fasteners. This would allow easier reconfiguration for different numbers of strings.

10. The method for tensioning the head could be applied to the construction of any non-stringed instrument incorporating a head, such as a drum or tambourine.

11. If reduced travel size is not an issue, the neck could be permanently attached by other methods including adhesives or non-removable fasteners.

Several travel oriented banjos already exist in the marketplace. One example is the Gold Tone Traveler (Gold Tone Musical Instruments, Titusville, Fla.) which incorporates a shorter than normal scale length and overall reduced size. The Risa Banjo Stick (Risa Musical Instruments GmbH, Germany) features a full length string scale of 26 inches on an all wood body frame, as well as a headless neck with tuners mounted on the rear of the body. U.S. Pat. No. 4,192,213 (Steinberger, Mar. 11, 1980) describes a headless guitar with tuners mounted on the body rather that in the traditional position at the end of the neck. U.S. Pat. No. 4,576,080 (McLellan, Mar. 18, 1986) describes a system with tuners mounted on the rear of the instrument body redirected by rollers. U.S. Pat. No. 4,191,085 (Litwin, Mar. 4, 1980) describes an instrument with a removable neck.

Existing travel banjo designs introduce compromises that affect playability, portability, durability, and sound quality. A common compromise such as found in the GoldTone example is a shortened scale length, reducing the overall length of the banjo but requiring the player to use a fingerboard several inches shorter that a conventional banjo scale length of 26⅜ inches. This alters the tuning of the banjo, making it useless for playing in certain keys, and forces the musician to adapt his technique to the shorter fingerboard, diminishing the effectiveness of practice time. The shorter overall length does not address the relative fragility of areas like the peghead, tuning mechanisms, or head-tensioning brackets, any of which can be damaged in transit by rough handling or inadequate packing. The Risa Banjo Stick eliminates the head altogether but requires headphones or an amplifier to generate an audible tone. The Steinberger design incorporates a fixed guitar neck which does not allow for removal for travel and does not sound like a banjo. The McLellan design moves the tuning mechanisms to the rear of the instrument, but does not place them in a protected position for durability. The Litwin design with neck storage within the body is not practical for a banjo type of body, allowing no room for a head tensioning system.

It is therefore an object of the invention to provide a travel banjo with a full scale neck.

It is another object of the invention to provide a way to remove the neck without tools or string removal to facilitate compact storage and transport.

It is another object of the invention to provide a string clamp to secure the bridge when the neck is removed.

It is another object of the invention to mount the tuning mechanisms on the rear of the travel banjo in a protected area, to reduce the chance of damage.

It is another object of the invention to include rollers to redirect the string path to the tuning mechanisms.

It is another object of the invention to use a drum type head to provide an authentic banjo sound.

### SUMMARY OF THE INVENTION

In accordance with the present invention, there is provided a musical instrument, specifically a travel banjo. The neck profile, fingerboard dimensions and string scale length are identical to a regular full sized banjo. The neck is attached to the body via a modified mortise and tenon joint and secured with a thumbscrew. The body consists of a front and back plate which are fastened together. The head, which is a commercial drum head, is tensioned by the force of the front and back plates being drawn together, applying pressure to the head and the tone ring. A string clamp is provided which attached to the front plate by a thumbscrew when needed to retain the strings and bridge in place when the neck is removed. The strings are attached to string posts at the end of the neck travelling down the neck, over a bridge positioned on the head, to a set of rollers. The rollers redirect the string travel from the front of the travel banjo to the rear where the tuning mechanisms are mounted in a protected area. The head and bridge are similar to a regular banjo to provide an authentic banjo sound.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a front view of an assembled instrument;

FIG. 2 is a rear view of an assembled instrument;

FIG. 3 is a perspective view of a detailing the assembly of the instrument;

FIG. 4 is a cross sectional view of an instrument, taken along line A of FIG. 1, displaying the string path around the roller to the tuning mechanism;

FIG. 5 is a perspective view of a neck end with strings attached to the string posts; and

FIG. 6 is an exploded side view of a detail of the neck attachment screw and string clamp.

For purposes of clarity and brevity, like elements and components will bear the same designations and numbering throughout the FIGURES.

### DESCRIPTION OF THE PREFERRED EMBODIMENT

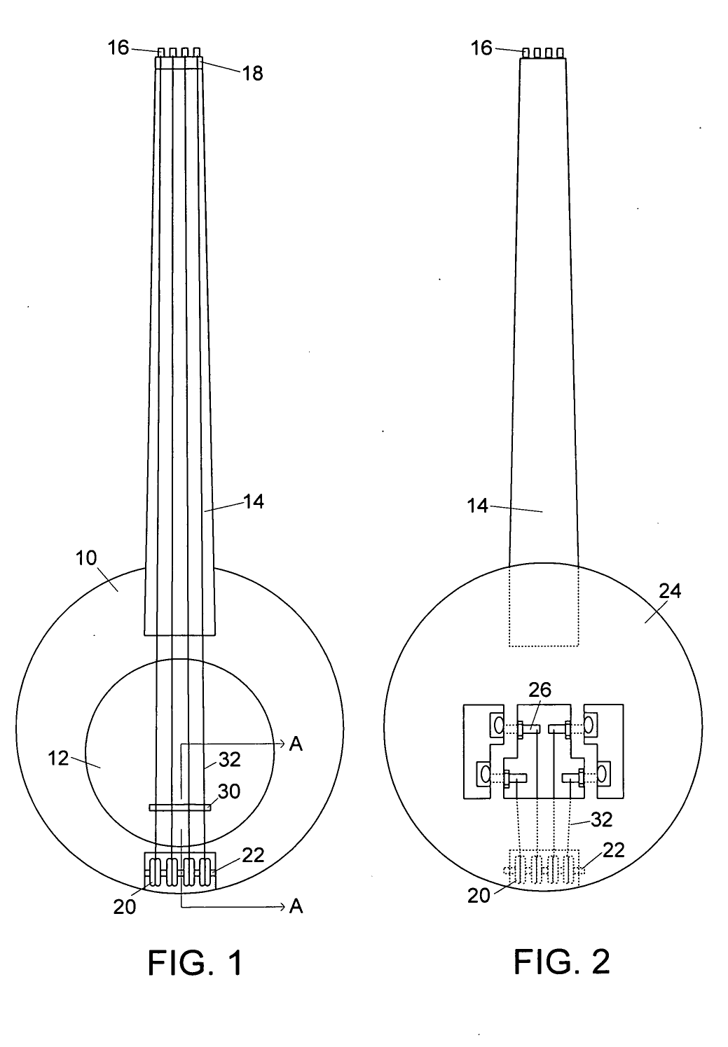

This is a stringed musical instrument, commonly referred to as a banjo, shown assembled in FIG. 1 (front view) and FIG. 2 (rear view). The main sounding surface consists of a standard head assembly 12, such as found in a conventional banjo or drum, upon which rests a moveable bridge 30. The bridge 30 is held in place by the tension of the string 32, each of which stretches from a post 16 at the end of the neck 14, over a nut 18, to a roller 20 mounted on an axle 22 at the other end of the instrument. Each roller 20 redirects a string 32 to a standard guitar-type tuning mechanism 26 on the body of the instrument, which consists of a front body plate 10 and a rear body plate 24. The neck 14 may be fretted or unfretted as desired, according to standard musical instrument design.

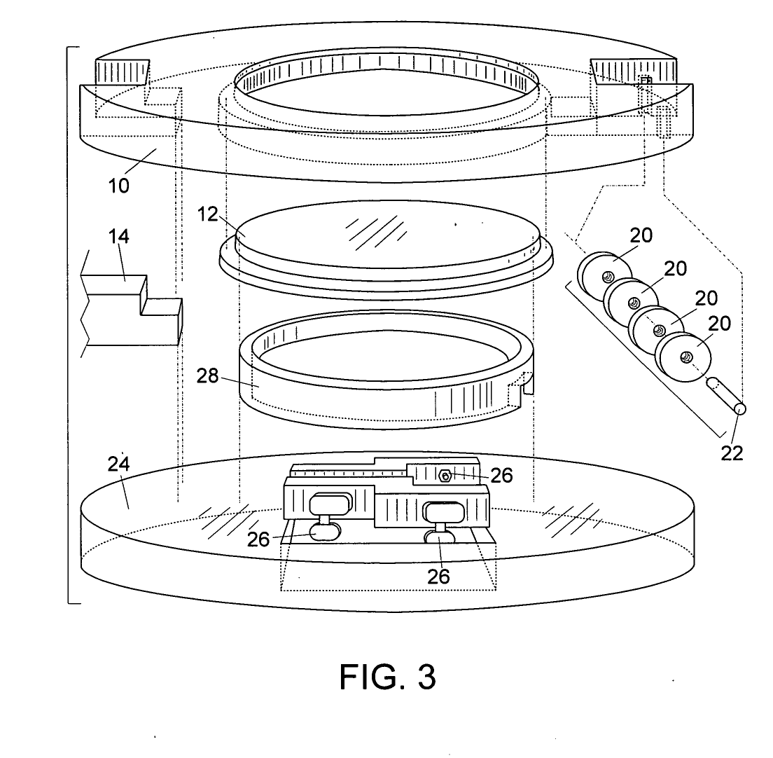

FIG. 3 shows an exploded view of the assembly of the instrument. This design eliminates most of the specialized hardware found on a conventional banjo. Tension is applied to the membrane portion of the head assembly 12 by the compression of the head assembly 12 and a tone ring 28 between the front body plate 10 and rear body plate 24. The front body plate 10 has a circular cutout which is the same diameter as the head assembly 12 membrane portion, and a recessed groove into which the hoop portion of the head assembly 12 is placed. As the front body plate 10 and rear body plate 24 are drawn together, the front body plate 10 pushes down on the head assembly 12 hoop, while the rear body plate 24 pushes up on the bottom of the tone ring 28. The top of the tone ring 28 pushes up on the back of the head assembly 12, tensioning the head assembly 12. When assembled, the exposed surface of the head assembly 12 is parallel with the top of the front body plate 10. Although no fasteners are shown, the front body plate 10 and rear body plate 24 are attached to each other via screws, bolts, adhesives, or by threaded connections machined into the plates themselves. Each roller 20 slides over the axle 22 which is mounted into grooves formed in the front body plate 10. Each tuning mechanism 26 is mounted on a raised area of the rear body plate 24. The vertical faces of these raised areas may optionally have slight offsets in alignment to allow each of the string 32 to stretch in a straight path to the corresponding roller 20.

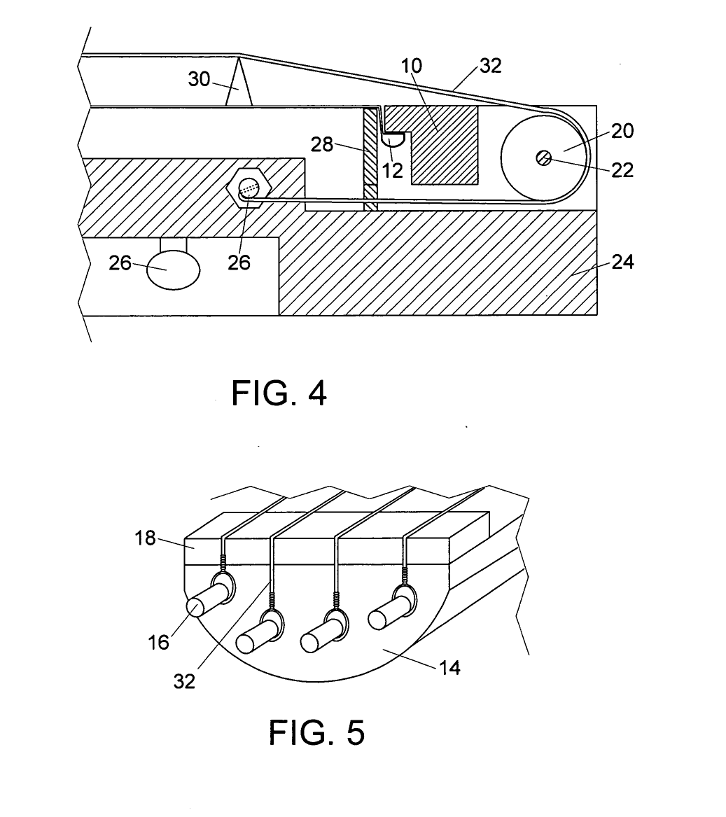

FIG. 4 details the path each string 32 takes to a tuning mechanism 26. Each tuning mechanism 26 is mounted on the rear body plate 24, underneath the head assembly 12. After passing over the bridge 30, each string 32 travels around a roller 20 which is mounted on an axle 22. This redirects the string 32 path 180 degrees back toward the tuning mechanism 26. By using a separate roller 20 for each string 32, pitch adjustment of the string 32 is easily and smoothly accomplished with very little friction or binding. This design also protects each tuning mechanism 26 from damage during transport.

FIG. 5 details the attachment of each string 32 to the neck 14. Each string 32 is attached to a post 16 at the end of the neck 14, stretched over the nut 18, down the length of the neck 14. Since the preferred embodiment is meant for a compact, travel-sized instrument, the overall length of the instrument is reduced by eliminating a conventional peghead design at the end of the neck 14.

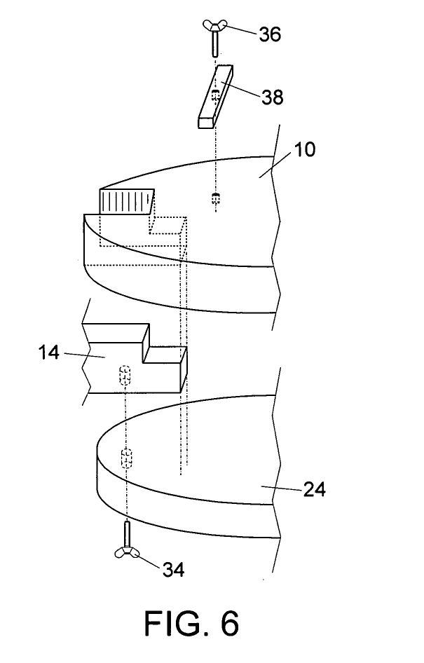

FIG. 6 details the neck 14 attachment and string_clamp 38. The tenon on the neck 14 fits into a mortise on the front body plate 10 and is secured through the back body plate with the neck_thumbscrew 34. The hole in the neck 14 is threaded to match the clamp_thumbscrew 36 threads. To hold the string 32 (not shown) in place when the neck 14 is removed, the string_clamp 38 is attached to the front body plate 10 with the clamp_thumbscrew 36, trapping the string 32 between the string_clamp 38 and the front body plate 10.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

1. A travel banjo for providing a rugged, easily transportable musical instrument while maintaining the sound and playability of a full size banjo comprising:
means for mounting a head assembly and providing an attachment point for a string clamp;
means for providing a sounding surface to convert string vibrations to audible tones, securely set to said means for mounting a head assembly and providing an attachment point for a string clamp;
means for providing a playing area;
means for anchoring the strings at the end of the neck, fixedly mounted to said means for providing a playing area;
means for redirecting the string travel from the front of the instrument to the rear tuning mechanism;
means for mounting the rollers allowing them to rotate freely, axially mounted to said means for redirecting the string travel from the front of the instrument to the rear tuning mechanism;
means for providing attachments for tuning mechanisms and a tone ring, detachably mounted to said means for providing a playing area;
means for tensioning a head assembly and contributing to the tonal characteristics, snugly coupled to said means for providing attachments for tuning mechanisms and a tone ring, and snugly coupled to said means for providing a sounding surface to convert string vibrations to audible tones;
means for transferring vibrational energy from the strings to a head assembly, functionally positioned to said means for providing a sounding surface to convert string vibrations to audible tones;
means for attaching the neck securely to the body assembly and allowing the neck to be dismounted without tools, threadably fastened to said means for providing attachments for tuning mechanisms and a tone ring;
means for attaching the string clamp securely to the front body plate without tools, detachably tightened to said means for mounting a head assembly and providing an attachment point for a string clamp; and
means for securing the strings to the front body plate when the neck is removed, removably fastened to said means for mounting a head assembly and providing an attachment point for a string clamp.

2. The travel banjo in accordance with claim 1, wherein said means for mounting a head assembly and providing an attachment point for a string clamp comprises a front body plate.

3. The travel banjo in accordance with claim 1, wherein said means for providing a sounding surface to convert string vibrations to audible tones comprises a head assembly.

4. The travel banjo in accordance with claim 1, wherein said means for providing a playing area comprises a neck.

5. The travel banjo in accordance with claim 1, wherein said means for anchoring the strings at the end of the neck comprises a post.

6. The travel banjo in accordance with claim 1, wherein said means for redirecting the string travel from the front of the instrument to the rear tuning mechanism comprises a roller.

7. The travel banjo in accordance with claim 1, wherein said means for mounting the rollers allowing them to rotate freely comprises an axle.

8. The travel banjo in accordance with claim 1, wherein said means for providing attachments for tuning mechanisms and a tone ring comprises a rear body plate.

9. The travel banjo in accordance with claim 1, wherein said means for tensioning a head assembly and contributing to the tonal characteristics comprises a tone ring.

10. The travel banjo in accordance with claim 1, wherein said means for transferring vibrational energy from the strings to a head assembly comprises a bridge.

11. The travel banjo in accordance with claim 1, wherein said means for attaching the neck securely to the body assembly and allowing the neck to be dismounted without tools comprises a neck_thumbscrew.

12. The travel banjo in accordance with claim 1, wherein said means for attaching the string clamp securely to the front body plate without tools comprises a clamp_thumbscrew.

13. The travel banjo in accordance with claim 1, wherein said means for securing the strings to the front body plate when the neck is removed comprises a string_clamp.

14. A travel banjo for providing a rugged, easily transportable musical instrument while maintaining the sound and playability of a full size banjo comprising:
a front body plate, for mounting a head assembly and providing an attachment point for a string clamp;
a head assembly, for providing a sounding surface to convert string vibrations to audible tones, securely set to said front body plate;
a neck, for providing a playing area;
a post, for anchoring the strings at the end of the neck, fixedly mounted to said neck;
a roller, for redirecting the string travel from the front of the instrument to the rear tuning mechanism;
an axle, for mounting the rollers allowing them to rotate freely, axially mounted to said roller;
a rear body plate, for providing attachments for tuning mechanisms and a tone ring, detachably mounted to said neck;
a tone ring, for tensioning a head assembly and contributing to the tonal characteristics, snugly coupled to said rear body plate, and snugly coupled to said head assembly;
a bridge, for transferring vibrational energy from the strings to a head assembly, functionally positioned to said head assembly;
a neck_thumbscrew, for attaching the neck securely to the body assembly and allowing the neck to be dismounted without tools, threadably fastened to said rear body plate;
a clamp_thumbscrew, for attaching the string clamp securely to the front body plate without tools, detachably tightened to said front body plate; and
a string_clamp, for securing the strings to the front body plate when the neck is removed, removably fastened to said front body plate.

15. A travel banjo for providing a rugged, easily transportable musical instrument while maintaining the sound and playability of a full size banjo comprising:
a front body plate, for mounting a head assembly and providing an attachment point for a string clamp;
a head assembly, for providing a sounding surface to convert string vibrations to audible tones, securely set to said front body plate;
a neck, for providing a playing area;
a post, for anchoring the strings at the end of the neck, fixedly mounted to said neck;
a roller, for redirecting the string travel from the front of the instrument to the rear tuning mechanism;
an axle, for mounting the rollers allowing them to rotate freely, axially mounted to said roller;
a rear body plate, for providing attachments for tuning mechanisms and a tone ring, detachably mounted to said neck;
a tone ring, for tensioning a head assembly and contributing to the tonal characteristics, snugly coupled to said rear body plate, and snugly coupled to said head assembly;
a bridge, for transferring vibrational energy from the strings to a head assembly, functionally positioned to said head assembly;
a neck_thumbscrew, for attaching the neck securely to the body assembly and allowing the neck to be dismounted without tools, threadably fastened to said rear body plate;
a clamp_thumbscrew, for attaching the string clamp securely to the front body plate without tools, detachably tightened to said front body plate; and
a string_clamp, for securing the strings to the front body plate when the neck is removed, removably fastened to said front body plate.
